(19) United States
(12) Patent Application Publication
(10) Pub. No.: US 2026/0303275 A1
(43) Pub. Date: Oct. 1, 2026

(54) COMMUNICATION METHOD AND APPARATUS

(71) Applicant: BEIJING XIAOMI MOBILE SOFTWARE CO., LTD., Beijing (CN)

(72) Inventors: Gaoming DUAN, Beijing (CN); Liangang CHI, Beijing (CN)

(73) Assignee: BEIJING XIAOMI MOBILE SOFTWARE CO., LTD., Beijing (CN)

(21) Appl. No.: 19/491,006

(22) PCT Filed: Jun. 9, 2023
(86) PCT No.: PCT/CN2023/099498

§ 371 Date: Dec. 8, 2025

(51) Int. Cl. H04L 5/00; H04L 27/26

(52) U.S. Cl. CPC H04L 5/0023; H04L 27/2666

(57) ABSTRACT

Provided in the present disclosure are a communication method and apparatus, belonging to the technical field of communications. The method includes determining a reference signal pattern, wherein the reference signal pattern is used for an orthogonal time frequency space (OTFS) modulation system, and a guard interval is provided between a data transmission position and a reference signal transmission position in the reference signal pattern.

### CROSS-REFERENCE TO RELATED APPLICATIONS

The present application is a U.S. National Phase of International Application No. PCT/CN2023/099498, filed on Jun. 9, 2023, the content of which is incorporated herein by reference in its entirety.

### TECHNICAL FIELD

The disclosure relates to the field of communication technology, specifically to a communication method and an apparatus.

### BACKGROUND

Orthogonal time frequency and space (OTFS) modulation is a two-dimensional modulation scheme designed in the delay-Doppler (DD) domain. Through two-dimensional transformation, a double-dispersive channel can be converted into an approximately flat-fading channel in the DD domain. In the related art, there is no reference signal pattern designed for OTFS systems.

### SUMMARY

According to a first aspect of the embodiments of the disclosure, a communication method is provided, performed by a transmitter device, including: determining a reference signal pattern, in which the reference signal pattern is used for an OTFS modulation system, and a guard interval is provided between a data transmission position and a reference signal transmission position in the reference signal pattern.

According to a second aspect of the embodiments of the disclosure, a communication method is provided, performed by a receiver device, including: receiving a reference signal pattern indicated by a transmitter device, in which the reference signal pattern is used for an OTFS modulation system, and a guard interval is provided between a data transmission position and a reference signal transmission position in the reference signal pattern.

According to a third aspect of the embodiments of the disclosure, a communication device is provided, which includes a transceiver; a memory; and a processor connected to the transceiver and the memory respectively, configured to control wireless signal transmission and reception of the transceiver by executing computer-executable instructions on the memory, and capable of implementing the method according to the above first aspect and the second aspect.

According to a fourth aspect of the embodiments of the disclosure, a non-transitory computer storage medium storing computer-executable instructions is provided. When the computer-executable instructions are executed by a processor, the method according to the above first aspect and the second aspect is caused to be implemented.

### BRIEF DESCRIPTION OF THE DRAWINGS

The above-mentioned and/or additional aspects and advantages of the disclosure become apparent and easily understandable from the following description of the embodiments in conjunction with the accompanying drawings.

FIG. 1 is a schematic diagram of a communication system according to an embodiment of the disclosure.

FIG. 2 is a schematic flowchart of a communication method according to an embodiment of the disclosure.

FIG. 3 is a schematic flowchart of a communication method according to an embodiment of the disclosure.

FIG. 4 is a schematic diagram of a reference signal pattern according to an embodiment of the disclosure.

FIG. 5 is a schematic flowchart of a communication method according to an embodiment of the disclosure.

FIG. 6 is a schematic diagram of a reference signal pattern according to an embodiment of the disclosure.

FIG. 7 is a schematic diagram of a reference signal pattern according to an embodiment of the disclosure.

FIG. 8 is a schematic diagram of a reference signal pattern according to an embodiment of the disclosure.

FIG. 9 is a schematic flowchart of a communication method according to an embodiment of the disclosure.

FIG. 10 is a schematic flowchart of a communication method according to an embodiment of the disclosure.

FIG. 11 is a schematic flowchart of a communication method according to an embodiment of the disclosure.

FIG. 12 is a schematic flowchart of a communication method according to an embodiment of the disclosure.

FIG. 13 is a schematic flowchart of an interactive communication method according to an embodiment of the disclosure.

FIG. 14 is a schematic diagram of a communication apparatus according to an embodiment of the disclosure.

FIG. 15 is a schematic diagram of a communication apparatus according to an embodiment of the disclosure.

FIG. 16 is a schematic diagram of a communication apparatus according to an embodiment of the disclosure.

FIG. 17 is a schematic diagram of a communication apparatus according to an embodiment of the disclosure.

FIG. 18 is a schematic diagram of a communication device according to an embodiment of the disclosure.

FIG. 19 is a schematic diagram of a communication device being a chip or a chip system according to an embodiment of the disclosure.

FIG. 20 is a schematic diagram of a communication system according to an embodiment of the disclosure.

### DETAILED DESCRIPTION

Exemplary embodiments are described in detail herein, with examples illustrated in the accompanying drawings. When the following description refers to the accompanying drawings, the same numerals in different drawings denote the same or similar elements unless otherwise indicated. The implementations described in the following exemplary embodiments do not represent all implementations consistent with the embodiments of the disclosure. Instead, they are merely examples of apparatuses and methods consistent with some aspects of the embodiments of the disclosure as detailed in the appended claims.

The terms used in the embodiments of the disclosure are for the purpose of describing specific embodiments only and are not intended to limit the embodiments of the disclosure. As used in the embodiments of the disclosure and the appended claims, the singular forms “a,” “an,” and “the” are also intended to include the plural forms unless the context clearly indicates otherwise. It should also be understood that the term “and/or” as used herein refers to and includes any or all possible combinations of one or more of the associated listed items.

It should be understood that although terms such as first, second, third, etc. may be used in the embodiments of the disclosure to describe various information, such information should not be limited to these terms. These terms are only used to distinguish the same type of information from each other. For example, without departing from the scope of the embodiments of the disclosure, first information may also be referred to as second information, and similarly, second information may also be referred to as first information. Depending on the context, the words “if” and “when” as used herein may be interpreted as “in a case where . . . ” or “when . . . ” or “in response to determining.”

In some embodiments, terms such as “apparatus” may be interpreted as physical or virtual, and their names are not limited to those recorded in the embodiments. Terms such as “apparatus,” “equipment,” “device,” “circuit,” “network element,” “node,” “function,” “unit,” “section,” “system,” “network,” “chip,” “chip system,” “entity,” and “subject” may be used interchangeably.

In some embodiments, terms such as “terminal,” “terminal device,” “user equipment (UE),” “user terminal,” “mobile station (MS),” “mobile terminal (MT),” “subscriber station,” “mobile unit,” “subscriber unit,” “wireless unit,” “remote unit,” “mobile device,” “wireless device,” “wireless communication device,” “remote device,” “mobile subscriber station,” “access terminal,” “wireless terminal,” “remote terminal,” “handset,” “user agent,” “mobile client,” and “client” may be used interchangeably.

In some embodiments, an access network device, a core network device, or a network device may be replaced with a terminal. For example, the embodiments of the disclosure may also be applied to a structure where communication between the access network device, the core network device, or the network device and the terminal is replaced with communication between a plurality of terminals (for example, also referred to as device-to-device (D2D), vehicle-to-everything (V2X), etc.). In this case, a structure in which the terminal has all or part of the functions of the access network device may also be adopted. In addition, terms such as “uplink” and “downlink” may also be replaced with terms corresponding to inter-terminal communication (for example, “side”). For example, an uplink channel, a downlink channel, etc. may be replaced with a side channel, and an uplink, a downlink, etc. may be replaced with a sidelink.

In some embodiments, the terminal may be replaced with the access network device, the core network device, or the network device. In this case, a structure in which the access network device, the core network device, or the network device has all or part of the functions of the terminal may also be adopted.

In some embodiments, the names of information and the like are not limited to those recorded in the embodiments. Terms such as “information,” “message,” “signal,” “signaling,” “report,” “configuration,” “indication,” “instruction,” “command,” “channel,” “parameter,” “domain,” “field,” “symbol,” “codebook,” “code word,” “code point,” “bit,” “data,” “program,” and “chip” may be used interchangeably.

In some embodiments, terms such as “side,” “sidelink,” “side communication,” “sidelink communication,” “direct connection,” “direct link,” “direct communication,” and “direct link communication” may be used interchangeably.

In some embodiments, terms such as “reference signal” and “pilot” may be used interchangeably.

In some embodiments, expressions such as “A to B” indicate that the included range includes A and B.

The embodiments of the disclosure are described in detail below. Examples of the embodiments are shown in the accompanying drawings, wherein the same or similar reference numerals denote the same or similar elements throughout. The embodiments described below with reference to the accompanying drawings are exemplary and are intended to explain the disclosure, but should not be construed as limiting the disclosure.

For ease of understanding, the terms involved in the disclosure are first introduced.

Orthogonal time-frequency-space (OTFS) modulation:

The OTFS modulation is a two-dimensional modulation scheme designed in the delay-Doppler (DD) domain. Through a series of two-dimensional transformations, a double-dispersive channel can be converted into an approximately flat-fading channel in the delay-Doppler domain. In this domain, each symbol in a data frame experiences the same almost invariant fading.

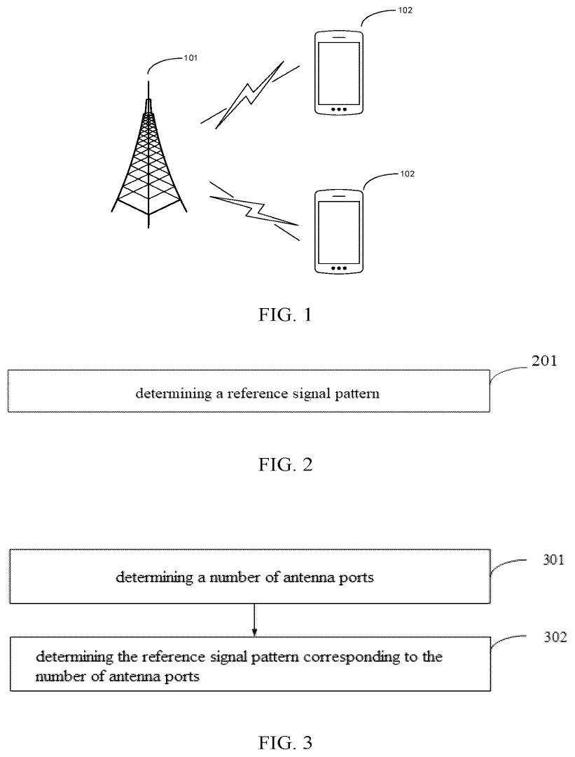

Please refer to FIG. 1, which is a schematic diagram of a communication system provided by an embodiment of the disclosure. This communication system may include but is not limited to one network device and one terminal. The number and form of devices shown in FIG. 1 are for illustration only and do not constitute a limitation on the embodiments of the disclosure. In practical applications, the communication system may include two or more network devices and two or more terminals. The communication system shown in FIG. 1 takes including one network device 101 and one terminal 102 as an example.

It should be noted that the technical solutions of the embodiments of the disclosure may be applied to various communication systems. For example: a long term evolution (LTE) system, a 5th generation (5G) mobile communication system, a 5G new radio (NR) system, or other future new-type mobile communication systems. It should also be noted that a sidelink in the embodiments of the disclosure may also be referred to as side link or direct link.

The network device 101 in the embodiments of the disclosure is an entity on the network side for transmitting or receiving signals. For example, the network device 101 may be an evolved NodeB (eNB), a transmission reception point (TRP), a next generation NodeB (gNB) in an NR system, a base station in other future mobile communication systems, or an access node in a wireless fidelity (WiFi) system, etc. The embodiments of the present disclosure do not limit the specific technologies and specific device forms adopted by the network device. The network device provided in the embodiments of the disclosure may be composed of a central unit (CU) and a distributed unit (DU), where the CU may also be called a control unit. The structure using CU-DU may split the network device (e.g., protocol layers of the network device), with functions of some protocol layers placed in the CU for centralized control, and functions of the remaining part or all of the protocol layers distributed in the DU, with the CU centrally controlling the DU.

The terminal 102 in the embodiments of the disclosure is an entity on the user side for receiving or transmitting signals, such as a mobile phone. The terminal may also be referred to as a terminal, a user equipment (UE), a mobile station (MS), a mobile terminal (MT), etc. The terminal may be a vehicle with communication functions, a smart vehicle, a mobile phone, a wearable device, a tablet computer (Pad), a computer with wireless transceiving functions, a virtual reality (VR) terminal, an augmented reality (AR) terminal, a wireless terminal in industrial control, a wireless terminal in self-driving, a wireless terminal in remote medical surgery, a wireless terminal in a smart grid, a wireless terminal in transportation safety, a wireless terminal in a smart city, a wireless terminal in a smart home, and so on. The embodiments of the present disclosure do not limit the specific technologies and specific device forms adopted by the terminal.

A transmitter device mentioned in the embodiments of the disclosure may refer to the network device 101, and a receiver device may refer to the terminal 102. It may be understood that in some embodiments, the transmitter device may refer to the terminal 102, and the receiver device may refer to the network device 101, which is not limited in the present disclosure. The communication system described in the embodiments of the disclosure is for the purpose of explaining the technical solutions of the embodiments more clearly, and does not constitute a limitation on the technical solutions provided by the embodiments of the disclosure. As those of ordinary skill in the art know, with the evolution of system architectures and the emergence of new service scenarios, the technical solutions provided by the embodiments of the disclosure are also applicable to similar technical problems.

It should be noted that a method for determining a reference signal pattern provided in any embodiment of the disclosure may be executed independently, or in combination with possible implementation methods in other embodiments, and may also be executed in combination with any technical solution in the related art.

The method for determining the reference signal pattern and an apparatus provided by the disclosure are described in detail below with reference to the accompanying drawings.

FIG. 2 is a schematic flowchart of a communication method according to an embodiment of the disclosure. The method is executed by a transmitter device. As shown in FIG. 2, the communication method may include the following steps.

At step 201, a reference signal pattern is determined.

In some embodiments of the disclosure, the transmitter device determines the reference signal pattern, enabling the transmitter device to send a reference signal according to the reference signal pattern to adapt to OTFS-MIMO systems.

In some embodiments of the disclosure, the reference signal pattern refers to an arrangement manner of a reference signal sequence in a time domain, a frequency domain, and a spatial domain.

In some embodiments of the disclosure, the reference signal pattern is used for an OTFS modulation system. The reference signal pattern may indicate information such as a reference signal transmission position and a data transmission position, and in some embodiments, a guard interval is provided between the reference signal transmission position and the data transmission position.

In some embodiments of the disclosure, there is no limitation on the type of the transmitter device, which may be a network device or a terminal.

In some embodiments of the disclosure, there is no limitation on the type of the reference signal, which may be, for example, a reference signal for channel estimation, a reference signal for signal demodulation, a reference signal for beam measurement, and the like.

In some embodiments of the disclosure, the reference signal pattern of the transmitter device may be agreed by a protocol, where the reference signal pattern has an association relationship with a number of antenna ports, that is, the transmitter device may determine the reference signal pattern based on the number of antenna ports required for sending the reference signal. The disclosure does not limit the relationship between the reference signal and the reference signal pattern, which may be, for example, one-to-one or many-to-one; that is, each reference signal may uniquely correspond to a reference signal pattern, and the corresponding reference signal is transmitted using a specific reference signal pattern, or a plurality of reference signals may respectively correspond to one reference signal pattern, that is, a plurality of reference signals are transmitted via the same reference signal pattern. The transmitter device determines a pattern of the reference signal to be sent based on a protocol agreement.

For example, the transmitter device is a network device, and the network device may determine a channel state information reference signal (CSI-RS) pattern based on the protocol agreement.

In summary, the method for determining a pattern provided by the disclosure, executed by the transmitter device, includes: determining the reference signal pattern, where the reference signal pattern is used for the OTFS modulation system, and the guard interval is provided between the data transmission position and the reference signal transmission position in the reference signal pattern. By determining the reference signal pattern, the disclosure enables the transmitter device to send the reference signal according to the pattern to adapt to the OTFS-MIMO system.

FIG. 3 is a schematic flowchart of a communication method according to an embodiment of the disclosure. The method is executed by a transmitter device. As shown in FIG. 3, based on the embodiment shown in FIG. 2, the communication method may include the following steps.

At step 301, a number of antenna ports is determined.

In some embodiments of the disclosure, the transmitter device may determine the number of antenna ports corresponding to antennas used for sending a reference signal to determine a reference signal pattern.

In some embodiments of the disclosure, the number of antenna ports may be 1, 2, 4, 8, 12, 16, 24, 32 supported by a new radio (NR) system, or other values, which is not limited by the disclosure

At step 302, the reference signal pattern corresponding to the number of antenna ports is determined.

In some embodiments of the disclosure, the transmitter device may determine the reference signal pattern corresponding to the number of antenna ports to map the reference signal pattern to a scheduling unit in a DD domain.

In some embodiments of the disclosure, an abscissa of the scheduling unit is delay, and an ordinate of the scheduling unit is Doppler.

In the disclosure, the following embodiments specifically introduce the reference signal patterns corresponding to the number of antenna ports being 1, 2, and 4 respectively. For a case where the number of antenna ports is greater than 4, the above three reference signal patterns may be flexibly combined to generate the corresponding reference signal pattern. For example, when the number of antenna ports is 8, two reference signal patterns for 4 antenna ports may be combined as the reference signal pattern for 8 antenna ports. For example, the reference signal pattern for 8 antenna ports may be a pattern formed by two reference signal patterns for 4 antenna ports arranged side by side.

Specifically, parameters of the reference signal pattern include at least one of the following, and the following parameters are all positive integers: lₚ, a delay domain coordinate of the reference signal transmission position; kₚ, a Doppler domain coordinate of the reference signal transmission position; l_{τ}, a number of OTFS symbols occupied by the guard interval in a delay domain (for example, if a maximum delay spread is 10 ms, and a duration of every two OTFS symbols in the delay domain is 1 ms, then l_{τ} is 10); or kᵥ, a number of Doppler domain OTFS subcarriers occupied by the guard interval in a Doppler domain. A Doppler shift may be positive or negative. When a distance between the transmitter device and a receiver device becomes shorter, a Doppler frequency for transmitting a signal increases, a wavelength becomes shorter, and the Doppler shift is positive. In other words, when the distance between the transmitter device and the receiver device becomes longer, the Doppler frequency for transmitting the signal decreases, the wavelength becomes longer, and the Doppler shift is negative.

Specifically, lₚ satisfies a first condition, and the first condition includes: 0<lₚ−l_{τ}<lₚ<lₚ+l_{τ}<M−1, where M represents a number of delay domain OTFS symbols in one scheduling unit. kₚ satisfies a second condition, and the second condition includes: 0<kₚ−kᵥ<kₚ<kₚ+kᵥ<N−1, where N represents a number of Doppler domain OTFS subcarriers in one scheduling unit.

In some embodiments of the disclosure, the above parameters may be determined by the network device or by the terminal itself, which is not limited by the disclosure. For example, the terminal may determine the delay of the signal via a downlink timing advance (TA), and by continuously receiving and demodulating the signal, perform circular convolution on a sequence of received signals to determine a delay spread of the signal.

In summary, the method for determining a pattern provided by the disclosure, executed by the transmitter device, includes: determining the number of antenna ports; determining the reference signal pattern corresponding to the number of antenna ports. The parameters of the reference signal pattern include at least one of: lₚ, the delay domain coordinate of the reference signal transmission position; kₚ, the Doppler domain coordinate of the reference signal transmission position; l_{τ}, the number of OTFS symbols occupied by the guard interval in the delay domain; or kᵥ, the number of Doppler domain OTFS subcarriers occupied by the guard interval in the Doppler domain. lₚ satisfies the first condition: 0<lₚ−l_{τ}<lₚ<lₚ+l_{τ}<M−1, where M represents a number of delay domain OTFS symbols in one scheduling unit. kₚ satisfies the second condition: 0<kₚ−kᵥ<kₚ<kₚ+kᵥ<N−1, where N represents a number of Doppler domain OTFS subcarriers in one scheduling unit. By setting the corresponding reference signal pattern based on the number of antenna ports and determining the relevant parameters in the reference signal pattern, the disclosure realizes the reference signal pattern in the DD domain.

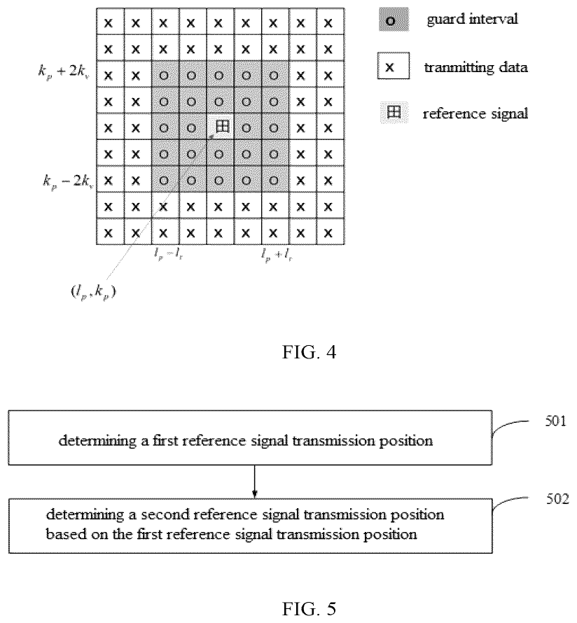

FIG. 4 shows a reference signal pattern with 1 antenna port according to an embodiment of the disclosure. This reference signal pattern may be determined by a transmitter device and have the following characteristics:

In the embodiment shown in FIG. 4, a DD domain coordinate of a reference signal (i.e., pilot) transmission position is (lₚ, kₚ).

In the embodiment shown in FIG. 4, since a time when a receiver device receives a signal is necessarily later than a time when the transmitter device transmits the signal, a delay value is always positive, which is manifested as a transmission data offset on the reference signal pattern. To prevent data transmitted on a left side of the reference signal from shifting to a right side due to delay, a delay domain coordinate range of the guard interval is from lₚ−l_{τ} to lₚ+l_{τ}. Since the Doppler shift may be positive or negative, to prevent overlap between two reference signals caused by Doppler shift, a Doppler domain coordinate range of the guard interval is from kₚ−2kᵥ to kₚ+2kᵥ. A value of the guard interval in the transmitter reference signal pattern is set to 0.

In the embodiment shown in FIG. 4, a delay domain coordinate range of the data transmission position is from 0 to lₚ−l_{τ}−1 and from lₚ+l_{τ}+1 to M−1. A Doppler domain coordinate range of the data transmission position is from 0 to kₚ−2kᵥ−1 and from kₚ+2kᵥ+1 to N−1.

In summary, by defining the reference signal transmission position, ranges of the guard interval, and the data transmission position range, the disclosure proposes the reference signal pattern for a single antenna to adapt to the OTFS-MIMO system.

FIG. 5 is a schematic flowchart of a communication method provided by an embodiment of the disclosure. The method is executed by a transmitter device, and the number of antenna ports for transmitting a reference signal is greater than or equal to 2. As shown in FIG. 5, based on the embodiment shown in FIG. 3, the communication method further includes the following steps.

At step 501, a first reference signal transmission position is determined.

In some embodiments of the disclosure, the transmitter device may determine the first reference signal transmission position to determine other reference signal transmission positions.

In some embodiments of the disclosure, the first reference signal transmission position is the reference signal transmission position corresponding to a first antenna port.

In some embodiments of the disclosure, the transmitter device may determine the first reference signal transmission position via a set constraint condition to ensure that there is a sufficient guard interval around the determined first reference signal transmission position. For the specific constraint condition, refer to the following embodiments.

At step 502, a second reference signal transmission position is determined based on the first reference signal transmission position.

In some embodiments of the disclosure, the transmitter device may determine the second reference signal transmission position based on the first reference signal transmission position.

Specifically, the transmitter device may determine the second reference signal transmission position based on the first reference signal transmission position and the guard interval.

In some embodiments of the disclosure, the second reference signal transmission position is the reference signal transmission position corresponding to a second antenna port.

In some embodiments of the disclosure, in a case where the number of antenna ports is greater than 2, other reference signal transmission positions may be determined based on the first reference signal transmission position. For example, when the number of antenna ports is 4, a third reference signal transmission position may be determined based on the first reference signal transmission position and the guard interval, and a fourth reference signal transmission position may be determined based on the first reference signal transmission position and the guard interval. For other numbers of antenna ports, other reference signal transmission positions may be determined in the same manner, which is not repeated here.

In summary, the method for determining a pattern provided by the disclosure, executed by the transmitter device where the number of antenna ports for transmitting the reference signal is greater than or equal to 2, includes: determining the first reference signal transmission position, which is the reference signal transmission position corresponding to the first antenna port; determining the second reference signal transmission position based on the first reference signal transmission position, where the second reference signal transmission position is the reference signal transmission position corresponding to the second antenna port. By setting the constraint condition to determine the first reference signal transmission position, and determining other reference signal transmission positions based on the first reference signal transmission position and the guard interval, the disclosure realizes the determination of the reference signal pattern and a stable transmission of signal data.

FIG. 6 shows a reference signal pattern with 2 antenna ports according to an embodiment of the disclosure. This reference signal pattern may be determined by a transmitter device and have the following characteristics.

In the embodiment shown in FIG. 6, a DD domain coordinate of a first reference signal transmission position is (lₚ, kₚ). Based on the first reference signal transmission position and the guard interval, it may be determined that a DD domain coordinate of a second reference signal transmission position is (lₚ+l_{τ}+1, kₚ).

In the embodiment shown in FIG. 6, since a time when a receiver device receives a signal is necessarily later than a time when the transmitter device transmits the signal, a delay value is always positive, which is manifested as a transmission data offset on the reference signal pattern. To prevent data transmitted on a left side of the reference signal from shifting to a right side due to delay, a delay domain coordinate range of the guard interval is from lₚ−l_{τ} to lₚ+2l_{τ}+1. Since the Doppler shift may be positive or negative, to prevent overlap between two reference signals caused by Doppler shift, a Doppler domain coordinate range of the guard interval is from kₚ−2kᵥ to kₚ+2kᵥ. A value of the guard interval in the transmitter reference signal pattern is set to 0.

In the embodiment shown in FIG. 6, a delay domain coordinate range of the data transmission position is from 0 to lₚ−l_{τ}−1 and from lₚ+2l_{τ}+2 to M−1. A Doppler domain coordinate range of the data transmission position is from 0 to kₚ−2kᵥ−1 and from kₚ+2kᵥ+1 to N−1.

In the embodiment shown in FIG. 6, on a plurality of scheduling units in a DD domain, a difference between delay domain coordinates of the reference signal transmission positions corresponding to any two antenna ports is |nl_{τ}+1|, where n is a positive integer greater than or equal to 1. A difference between Doppler domain coordinates of the reference signal transmission positions corresponding to any two antenna ports is |mkᵥ+1, where m is an even number greater than or equal to 2.

In summary, by defining the reference signal transmission position, ranges of the guard interval, and the data transmission position range, the disclosure proposes the reference signal pattern for two antennas to adapt to the OTFS-MIMO system.

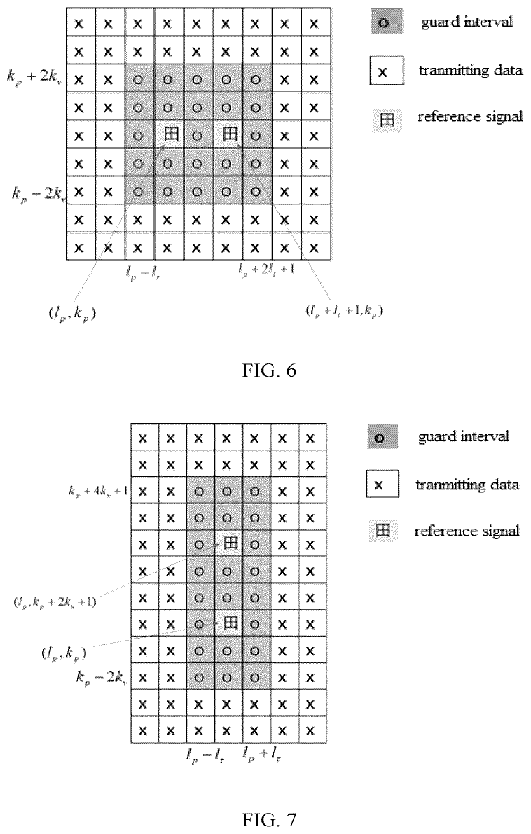

FIG. 7 shows a reference signal pattern with 2 antenna ports according to another embodiment of the disclosure. This reference signal pattern may be determined by a transmitter device and have the following characteristics.

In the embodiment shown in FIG. 7, a DD domain coordinate of a first reference signal transmission position is (lₚ, kₚ). Based on the first reference signal transmission position and the guard interval, it may be determined that a DD domain coordinate of a second reference signal transmission position is (lₚ, kₚ+2kᵥ+1).

In the embodiment shown in FIG. 7, since a time when a receiver device receives a signal is necessarily later than a time when the transmitter device transmits the signal, a delay value is always positive, which is manifested as a transmission data offset on the reference signal pattern. To prevent data transmitted on a left side of the reference signal from shifting to a right side due to delay, a delay domain coordinate range of the guard interval is from lₚ−l_{τ} to lₚ+l_{τ}. Since the Doppler shift may be positive or negative, to prevent overlap between two reference signals caused by Doppler shift, a Doppler domain coordinate range of the guard interval is from kₚ−2kᵥ to kₚ+4kᵥ+1. A value of the guard interval in the transmitter reference signal pattern is set to 0.

In the embodiment shown in FIG. 7, a delay domain coordinate range of the data transmission position is from 0 to lₚ−l_{τ}−1 and from lₚ+l_{τ}+1 to M−1. A Doppler domain coordinate range of the data transmission position is from 0 to kₚ−2kᵥ−1 and from kₚ+4kᵥ+2 to N−1.

In the embodiment shown in FIG. 7, on a plurality of scheduling units in a DD domain, a difference between delay domain coordinates of the reference signal transmission positions corresponding to any two antenna ports is |nl_{τ}+1|, where n is a positive integer greater than or equal to 1. A difference between Doppler domain coordinates of the reference signal transmission positions corresponding to any two antenna ports is |mkᵥ+1|, where m is an even number greater than or equal to 2.

In summary, by defining the reference signal transmission position, ranges of the guard interval, and the data transmission position range, the disclosure proposes the reference signal pattern for two antennas to adapt to the OTFS-MIMO system.

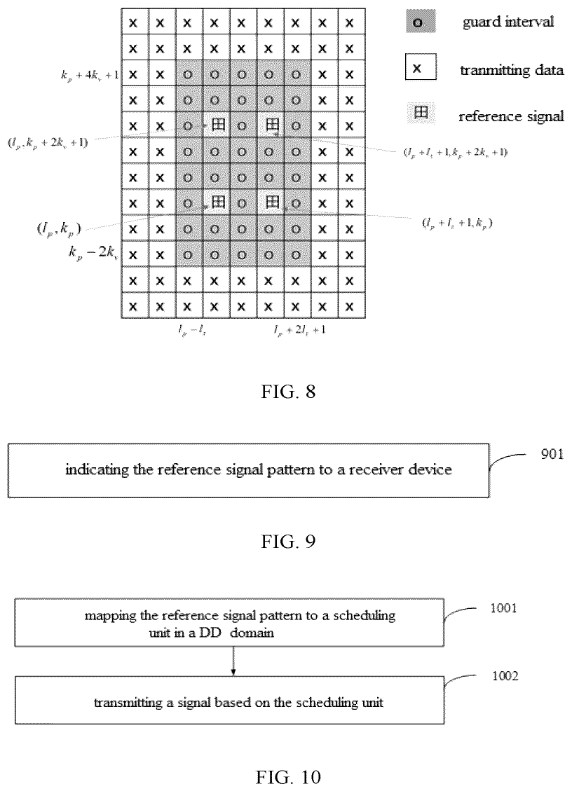

FIG. 8 shows a reference signal pattern with 4 antenna ports according to another embodiment of the disclosure. This reference signal pattern may be determined by a transmitter device and have the following characteristics.

In the embodiment shown in FIG. 8, a DD domain coordinate of a first reference signal transmission position is (lₚ, kₚ). Based on the first reference signal transmission position and the guard interval, it may be determined that a DD domain coordinate of a second reference signal transmission position is (lₚ, kₚ+2kᵥ+1). A DD domain coordinate of a third reference signal transmission position is (lₚ+l_{τ}+1, kₚ). A DD domain coordinate of a fourth reference signal transmission position is (lₚ+l_{τ}+1, kₚ+2kᵥ+1). The third reference signal transmission position corresponds to a third antenna port, and a fourth reference signal transmission position corresponds to a fourth antenna port.

In the embodiment shown in FIG. 8, since a time when a receiver device receives a signal is necessarily later than a time when the transmitter device transmits the signal, a delay value is always positive, which is manifested as a transmission data offset on the reference signal pattern. To prevent data transmitted on a left side of the reference signal from shifting to a right side due to delay, a delay domain coordinate range of the guard interval is from lₚ−l_{τ} to lₚ+2l_{τ}+1. Since the Doppler shift may be positive or negative, to prevent overlap between two reference signals caused by Doppler shift, a Doppler domain coordinate range of the guard interval is from kₚ−2kᵥ to kₚ+4kᵥ+1. A value of the guard interval in the transmitter reference signal pattern is set to 0.

In the embodiment shown in FIG. 8, a delay domain coordinate range of the data transmission position is from 0 to lₚ−l_{τ}−1 and from lₚ+2l_{τ}+2 to M−1. A Doppler domain coordinate range of the data transmission position is from 0 to kₚ−2kᵥ−1 and from kₚ+4kᵥ+2 to N−1.

In the embodiment shown in FIG. 8, on a plurality of scheduling units in a DD domain, a difference between delay domain coordinates of the reference signal transmission positions corresponding to any two antenna ports is |nl_{τ}+1|, where n is a positive integer greater than or equal to 1. A difference between Doppler domain coordinates of the reference signal transmission positions corresponding to any two antenna ports is |mkᵥ+1|, where m is an even number greater than or equal to 2.

In summary, by defining the reference signal transmission position, ranges of the guard interval, and the data transmission position range, the disclosure proposes the reference signal pattern for four antennas to adapt to the OTFS-MIMO system.

However, it should be understood that the reference signal pattern for four antennas may also be formed by combining two reference signal patterns for two antennas as described in FIG. 7 or FIG. 8, or by combining four reference signal patterns for one antenna to form the reference signal pattern for four antennas.

FIG. 9 is a schematic flowchart of a communication method provided by an embodiment of the disclosure. The method is executed by a transmitter device. Based on the above-described embodiments, the communication method further includes the following step.

At step 901, the reference signal pattern is indicated to a receiver device.

In some embodiments of the disclosure, the transmitter device may indicate the reference signal pattern to the receiver device, enabling the receiver device to determine which pattern the transmitter device uses to send the reference signal, as well as to determine the reference signal transmission position and the data transmission position.

The disclosure imposes no limitation on a timing at which the transmitter device indicates the reference signal pattern to the receiver device. The reference signal pattern may be sent before the reference signal is transmitted or be sent simultaneously with the reference signal.

In some embodiments of the disclosure, there is no limitation on the type of the receiver device, which may be a network device or a terminal.

In some embodiments of the disclosure, step 901 is optional. If the receiver device has been preconfigured with reference signal pattern information (i.e., the receiver device has obtained the reference signal pattern corresponding to each reference signal), the transmitter device may not execute step 901.

In summary, the method for determining a pattern provided by the disclosure, executed by the transmitter device, includes: indicating the reference signal pattern to the receiver device. In the disclosure, the transmitter device indicates the reference signal pattern to the receiver device, which enables the receiver device to determine which pattern the transmitter uses to send the reference signal.

FIG. 10 is a schematic flowchart of a communication method provided by an embodiment of the disclosure. The method is executed by a transmitter device. Based on the above embodiments, the communication method further includes the following steps.

At step 1001, the reference signal pattern is mapped to a scheduling unit in a DD domain.

In some embodiments of the disclosure, the transmitter device may map the reference signal pattern to the scheduling unit in the DD domain, enabling the transmitter device to transmit signals based on the scheduling unit.

In some embodiments of the disclosure, an abscissa of the scheduling unit is delay, and an ordinate of the scheduling unit is Doppler.

At step 1002, a signal is transmitted based on the scheduling unit.

In some embodiments of the disclosure, the transmitter device may transmit the signal based on the scheduling unit.

In summary, the method for determining a pattern provided by the disclosure, executed by the transmitter device, includes: mapping the reference signal pattern to the scheduling unit in the DD domain; transmitting the signal based on the scheduling unit. By mapping the reference signal pattern to the scheduling unit in the DD domain, the disclosure utilizes the scheduling unit to realize a transmission of the reference signal according to the determined pattern.

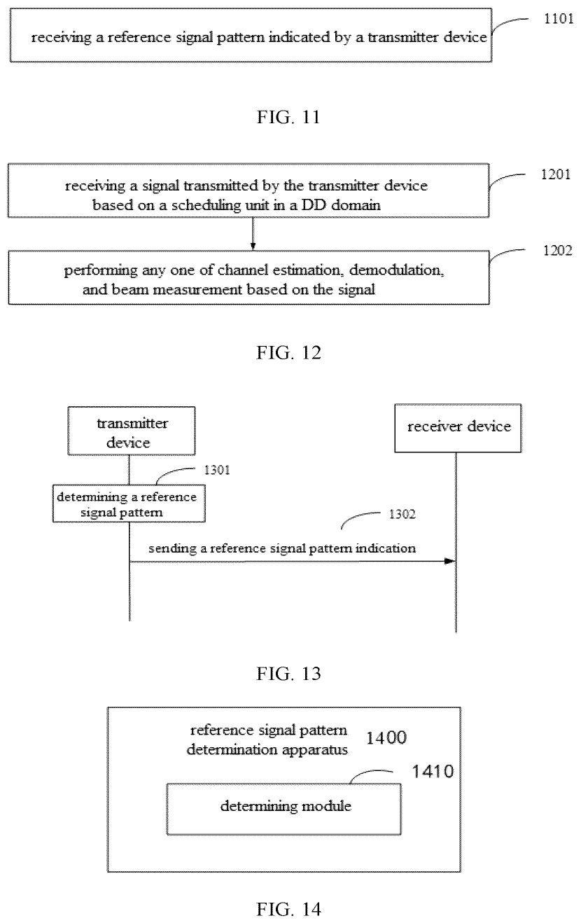

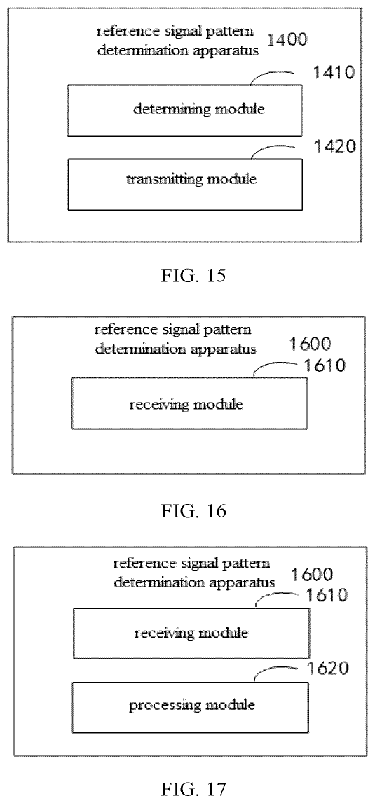

FIG. 11 is a schematic flowchart of a communication method according to an embodiment of the disclosure. The method is executed by a receiver device. Based on the above embodiments, the communication method further includes the following steps.

At step 1101, a reference signal pattern indicated by a transmitter device is received.

In some embodiments of the disclosure, the receiver device may receive the reference signal pattern indicated by the transmitter device to mapping the reference signal pattern to a scheduling unit.

In some embodiments of the disclosure, the reference signal pattern is used for an OTFS modulation system. A guard interval is provided between a data transmission position and a reference signal transmission position in the reference signal pattern.

In some embodiments of the disclosure, there is no limitation on the type of the receiver device, which may be a network device or a terminal.

In some embodiments of the disclosure, there is no limitation on the type of the reference signal, which may be, for example, a reference signal for channel estimation, a reference signal for signal demodulation, a reference signal for beam measurement, and the like.

In some embodiments of the disclosure, the reference signal pattern may be agreed by a protocol, where the reference signal pattern has an association relationship with a number of antenna ports, that is, the receiver device may determine the reference signal pattern based on the number of antenna ports determined for sending the reference signal. The disclosure does not limit the relationship between the reference signal and the reference signal pattern, which may be, for example, one-to-one or many-to-one; that is, each reference signal may uniquely correspond to a reference signal pattern, or a plurality of reference signals may correspond to one reference signal pattern.

Specifically, parameters of the reference signal pattern include at least one of the following, and the following parameters are all positive integers: lₚ, a delay domain coordinate of the reference signal transmission position; kₚ, a Doppler domain coordinate of the reference signal transmission position; l_{τ}, a number of OTFS symbols occupied by the guard interval in a delay domain (for example, if a maximum delay spread is 10 ms, and a duration of every two OTFS symbols in the delay domain is 1 ms, then l_{τ} is 10); or kᵥ, a number of Doppler domain OTFS subcarriers occupied by the guard interval in a Doppler domain. A Doppler shift may be positive or negative. When a distance between the transmitter device and a receiver device becomes shorter, a Doppler frequency for transmitting a signal increases, a wavelength becomes shorter, and the Doppler shift is positive. In other words, when the distance between the transmitter device and the receiver device becomes longer, the Doppler frequency for transmitting the signal decreases, the wavelength becomes longer, and the Doppler shift is negative.

Specifically, lₚ satisfies a first condition, and the first condition includes: 0<lₚ−l_{τ}<lₚ<lₚ+l_{τ}<M−1, where M represents a number of delay domain OTFS symbols in one scheduling unit. kₚ satisfies a second condition, and the second condition includes: 0<kₚ−kᵥ<kₚ<kₚ+kᵥ<N−1, where N represents a number of Doppler domain OTFS subcarriers in one scheduling unit.

Specifically, in an embodiment where the number of antenna ports is 1, a DD domain coordinate of a reference signal transmission position is (lₚ, kₚ). A delay domain coordinate range of the guard interval is from lₚ−l_{τ} to lₚ+l_{τ}. A Doppler domain coordinate range of the guard interval is from kₚ−2kᵥ to kₚ+2kᵥ. A delay domain coordinate range of the data transmission position is from 0 to lₚ−l_{τ}−1 and from lₚ+l_{τ}+1 to M−1. A Doppler domain coordinate range of the data transmission position is from 0 to kₚ−2kᵥ−1 and from kₚ+2kᵥ+1 to N−1. The specific setting methods of the aforementioned parameters may refer to the embodiment shown in FIG. 4, and are not repeated here.

Specifically, in an embodiment where the number of antenna ports is 2, a first reference signal transmission position corresponds to a first antenna port, and a second reference signal transmission position corresponds to a second antenna port. A DD domain coordinate of the first reference signal transmission position is (lₚ, kₚ). A DD domain coordinate of the second reference signal transmission position is (lₚ+l_{τ}+1, kₚ). A delay domain coordinate range of the guard interval is from lₚ−l_{τ} to lₚ+2l_{τ}+1. A Doppler domain coordinate range of the guard interval is from kₚ−2kᵥ to kₚ+2kᵥ. A delay domain coordinate range of the data transmission position is from 0 to lₚ−l_{τ}−1 and from lₚ+2l_{τ}+2 to M−1. A Doppler domain coordinate range of the data transmission position is from 0 to kₚ−2kᵥ−1 and from kₚ+2kᵥ+1 to N−1. The specific setting methods of the aforementioned parameters may refer to the embodiment shown in FIG. 6, and are not repeated here.

Specifically, in another embodiment where the number of antenna ports is 2, a first reference signal transmission position corresponds to a first antenna port, and a second reference signal transmission position corresponds to a second antenna port. A DD domain coordinate of the first reference signal transmission position is (lₚ, kₚ). A DD domain coordinate of the second reference signal transmission position is (lₚ, kₚ+2kᵥ+1). A delay domain coordinate range of the guard interval is from lₚ−l_{τ} to lₚ+l_{τ}. A Doppler domain coordinate range of the guard interval is from kₚ−2kᵥ to kₚ+4kᵥ+1. A delay domain coordinate range of the data transmission position is from 0 to lₚ−l_{τ}−1 and from lₚ+l_{τ}+1 to M−1. A Doppler domain coordinate range of the data transmission position is from 0 to kₚ−2kᵥ−1 and from kₚ+4kᵥ+2 to N−1. The specific setting methods of the aforementioned parameters may refer to the embodiment shown in FIG. 7, and are not repeated here.

Specifically, in an embodiment where the number of antenna ports is 4, a first reference signal transmission position corresponds to a first antenna port, a second reference signal transmission position corresponds to a second antenna port, a third reference signal transmission position corresponds to a third antenna port, and a fourth reference signal transmission position corresponds to a fourth antenna port. A DD domain coordinate of the first reference signal transmission position is (lₚ, kₚ). A DD domain coordinate of the second reference signal transmission position is (lₚ, kₚ+2kᵥ+1). A DD domain coordinate of the third reference signal transmission position is (lₚ+l_{τ}+1, kₚ). ADD domain coordinate of the fourth reference signal transmission position is (lₚ+l_{τ}+1, kₚ+2kᵥ+1). A delay domain coordinate range of the guard interval is from lₚ−l_{τ} to lₚ+2l_{τ}+1. A Doppler domain coordinate range of the guard interval is from kₚ−2kᵥ to kₚ+4kᵥ+1. The specific setting methods of the aforementioned parameters may refer to the embodiment shown in FIG. 8, and are not repeated here.

Specifically, in some embodimnets, on a plurality of scheduling units in a DD domain, a difference between delay domain coordinates of the reference signal transmission positions corresponding to any two antenna ports is |nl_{τ}+1|, where n is a positive integer greater than or equal to 1. A difference between Doppler domain coordinates of the reference signal transmission positions corresponding to any two antenna ports is |mkᵥ+1|, where m is an even number greater than or equal to 2.

FIG. 12 is a schematic flowchart of a communication method provided by an embodiment of the disclosure. The method is executed by a receiver device. Based on the above-described embodiments, the communication method further includes the following step.

At step 1201, a signal transmitted by the transmitter device based on a scheduling unit in a DD domain is received.

In some embodiments of the disclosure, the receiver device may receive the signal transmitted by the transmitter device based on the scheduling unit in the DD domain to perform any one of channel estimation, demodulation, and beam measurement.

In some embodiments of the disclosure, an abscissa of the scheduling unit is delay, and an ordinate of the scheduling unit is Doppler.

At step 1202, any one of channel estimation, demodulation, and beam measurement is performed based on the signal.

In some embodiments of the disclosure, the receiver device may perform any one of channel estimation, demodulation, and beam measurement based on the signal.

Specifically, the receiver device may perform relevant tasks based on a type of the signal. For example, the receiver device receives a channel state information reference signal (CSI-RS) to perform the channel estimation.

In summary, the method for determining a pattern provided by the disclosure, executed by the receiver device, includes: receiving the signal transmitted by the transmitter device based on the scheduling unit in the DD domain; performing any one of channel estimation, demodulation, and beam measurement based on the signal. By receiving the signal transmitted based on the scheduling unit in the DD domain and performing relevant tasks, the disclosure may adapt to the OTFS-MIMO system.

FIG. 13 provides a flowchart of an interactive communication method. As shown in FIG. 13, the interactive method may include the following steps.

At step 1301, a transmitter device determines a reference signal pattern.

In some embodiments of the disclosure, the reference signal pattern is used for an OTFS modulation system, and a guard interval is provided between a data transmission position and a reference signal transmission position in the reference signal pattern.

At step 1302, the transmitter device sends the reference signal pattern to a receiver device.

The principles of the above steps 1301-1302 are the same as those of the steps in the embodiments shown in FIGS. 2-12 above, and reference may be made to the relevant descriptions in FIGS. 2-12, which is not repeated here.

In some embodiments, the above method may include the methods described in the embodiments on the transmitter device side and the receiver device side mentioned above, which is not repeated here.

In summary, according to the communication method provided by the disclosure, through interaction between the transmitter device and the receiver device, the transmitter device determines the reference signal pattern, where the reference signal pattern is used for the OTFS modulation system, and the guard interval is provided between the reference signal transmission position and the data transmission position in the reference signal pattern. The transmitter device sends the reference signal pattern to the receiver device. In the solution of the disclosure, the transmitter device determines the reference signal pattern and indicates the pattern to the receiver device, therefore realizing communication and transmission in the OTFS system.

FIG. 14 is a schematic diagram of a communication apparatus 1400 provided by an embodiment of the disclosure.

As shown in FIG. 14, the communication apparatus 1400 includes a determining module 1410, configured to determine a reference signal pattern, where the reference signal pattern is used for OTFS modulation, and a guard interval is provided between a data transmission position and a reference signal transmission position in the reference signal pattern.

In summary, the communication apparatus provided by the disclosure includes the determining module configured to determine the reference signal pattern, where the reference signal pattern is used for the OTFS modulation, and the guard interval is provided between the data transmission position and the reference signal transmission position in the reference signal pattern. According to the communication method provided by the disclosure, the reference signal pattern is determined, enabling reference signals to be transmitted according to the determined pattern.

In some embodiments of the disclosure, the determining module 1410 is configured to determine the reference signal pattern, in which the reference signal pattern is used for an OTFS modulation system, and the guard interval is provided between the data transmission position and the reference signal transmission position in the reference signal pattern.

In some embodiments of the disclosure, the determining module 1410 is further configured to determine a number of antenna ports, and determine the reference signal pattern corresponding to the number of antenna ports.

In some embodiments of the disclosure, parameters of the reference signal pattern includes at least one of: lₚ, a delay domain coordinate of the reference signal transmission position; kₚ, a Doppler domain coordinate of the reference signal transmission position; l_{τ}, a number of OTFS symbols occupied by the guard interval in a delay domain; or kᵥ, a number of Doppler domain OTFS subcarriers occupied by the guard interval in a Doppler domain.

In some embodiments of the disclosure, lₚ satisfies a first condition, and the first condition includes: 0<lₚ−l_{τ}<lₚ<lₚ+l_{τ}<M−1, where M represents a number of delay domain OTFS symbols in one scheduling unit; and kₚ satisfies a second condition, and the second condition includes: 0<kₚ−kᵥ<kₚ<kₚ+kᵥ<N−1, where N represents a number of Doppler domain OTFS subcarriers in one scheduling unit.

In some embodiments of the disclosure, in a case where the number of antenna ports is 1, a DD domain coordinate of the reference signal transmission position is (lₚ, kₚ); a delay domain coordinate range of the guard interval is from lₚ−l_{τ} to lₚ+l_{τ}, and a Doppler domain coordinate range of the guard interval is from kₚ−2kᵥ to kₚ+2kᵥ; a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+2kᵥ+1 to N−1.

In some embodiments of the disclosure, in a case where the number of antenna ports is greater than or equal to 2, determining the reference signal pattern corresponding to the number of antenna ports includes: determining a first reference signal transmission position, in which the first reference signal transmission position is the reference signal transmission position corresponding to a first antenna port; and determining a second reference signal transmission position based on the first reference signal transmission position, in which the second reference signal transmission position is the reference signal transmission position corresponding to a second antenna port.

In some embodiments of the disclosure, in a case where the number of antenna ports is 2, a DD domain coordinate of the first reference signal transmission position is (lₚ, kₚ); a DD domain coordinate of the second reference signal transmission position is (lₚ+l_{τ}+1, kₚ); a delay domain coordinate range of the guard interval is from lₚ−l_{τ} to lₚ+2l_{τ}+1, and a Doppler domain coordinate range of the guard interval is from kₚ−2kᵥ to kₚ+2kᵥ; a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+2kᵥ+1 to N−1.

In some embodiments of the disclosure, in a case where the number of antenna ports is 2, a DD domain coordinate of the first reference signal transmission position is (lₚ, kₚ); a DD domain coordinate of the second reference signal transmission position is (lₚ, kₚ+2kᵥ+1); a delay domain coordinate range of the guard interval is from lₚ−l_{τ} to lₚ+l_{τ}, and a Doppler domain coordinate range of the guard interval is from kₚ−2kᵥ to kₚ+4kᵥ+1; a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+4kᵥ+2 to N−1.

In some embodiments of the disclosure, in a case where the number of antenna ports is 4, a third reference signal transmission position corresponds to a third antenna port, a fourth reference signal transmission position corresponds to a fourth antenna port, and a DD domain coordinate of the first reference signal transmission position is (lₚ, kₚ); a DD domain coordinate of the second reference signal transmission position is (lₚ, kₚ+2kᵥ+1), a DD domain coordinate of the third reference signal transmission position is (lₚ+l_{τ}+1, kₚ), and a DD domain coordinate of the fourth reference signal transmission position is (lₚ+l_{τ}+1, kₚ+2kᵥ+1); a delay domain coordinate range of the guard interval is from lₚ−l_{τ} to lₚ+2l_{τ}+1, and a Doppler domain coordinate range of the guard interval is from kₚ−2kᵥ to kₚ+4kᵥ+1; a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+4kᵥ+2 to N−1.

In some embodiments of the disclosure, on a plurality of scheduling units in a DD domain, a difference between delay domain coordinates of the reference signal transmission positions corresponding to any two antenna ports is |nl_{τ}+1|, where n is a positive integer greater than or equal to 1; and a difference between Doppler domain coordinates of the reference signal transmission positions corresponding to any two antenna ports is |mkᵥ+1|, where m is an even number greater than or equal to 2.

In some embodiments of the disclosure, the determining module 1410 is further configured to indicate the reference signal pattern to a receiver device.

In some embodiments of the disclosure, the determining module 1410 is configured to map the reference signal pattern to a scheduling unit in a DD domain.

In some embodiments of the disclosure, the communication apparatus 1400 further includes a transmitting module 1420. The transmitting module 1420 is configured to transmit a signal based on the scheduling unit.

FIG. 16 is a schematic structural diagram of a communication apparatus 1600 provided by an embodiment of the disclosure.

As shown in FIG. 16, the communication apparatus 1600 includes a receiving module 1610, configured to receive a reference signal pattern indicated by a transmitter device, where the reference signal pattern is used for OTFS modulation, and a guard interval is provided between a data transmission position and a reference signal transmission position in the reference signal pattern.

In summary, the communication apparatus provided by the disclosure includes the receiving module configured to receive the reference signal pattern indicated by the transmitter device, where the reference signal pattern is used for the OTFS modulation, and the guard interval is provided between a data transmission position and a reference signal transmission position in the reference signal pattern. According to the communication method provided by the disclosure, by receiving an indication of the reference signal pattern sent by the transmitter device, transmitted signal information is received based on the reference signal pattern, so as to perform any one of channel estimation, demodulation, and beam measurement.

In some embodiments of the disclosure, the reference signal pattern is agreed by a protocol, and the reference signal pattern has a correlative relationship with a number of antenna ports.

In some embodiments of the disclosure, parameters of the reference signal pattern includes at least one of: lₚ, a delay domain coordinate of the reference signal transmission position; kₚ, a Doppler domain coordinate of the reference signal transmission position; l_{τ}, a number of OTFS symbols occupied by the guard interval in a delay domain; or kᵥ, a number of Doppler domain OTFS subcarriers occupied by the guard interval in a Doppler domain.

In some embodiments of the disclosure, lₚ satisfies a first condition, and the first condition includes: 0<lₚ−l_{τ}<lₚ<lₚ+l_{τ}<M−1, where M represents a number of delay domain OTFS symbols in one scheduling unit; and kₚ satisfies a second condition, and the second condition includes: 0<kₚ−kᵥ<kₚ<kₚ+kᵥ<N−1, where N represents a number of Doppler domain OTFS subcarriers in one scheduling unit.

In some embodiments of the disclosure, in a case where the number of antenna ports is 1, a DD domain coordinate of the reference signal transmission position is (lₚ, kₚ); a delay domain coordinate range of the guard interval is from lₚ−l_{τ} to lₚ−l_{τ}, and a Doppler domain coordinate range of the guard interval is from kₚ−2kᵥ to kₚ+2kᵥ; a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+2kᵥ+1 to N−1.

In some embodiments of the disclosure, in a case where the number of antenna ports is 2, a first reference signal transmission position corresponds to a first antenna port, a second reference signal transmission position corresponds to a second antenna port, and a DD domain coordinate of the first reference signal transmission position is (lₚ, kₚ); a DD domain coordinate of the second reference signal transmission position is (lₚ+l_{τ}+1, kₚ) ; a delay domain coordinate range of the guard interval is from lₚ−l_{τ} to lₚ+2l_{τ}+1, and a Doppler domain coordinate range of the guard interval is from kₚ−2kᵥ to kₚ+2kᵥ; a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+2kᵥ+1 to N−1.

In some embodiments of the disclosure, in a case where the number of antenna ports is 2, a first reference signal transmission position corresponds to a first antenna port, a second reference signal transmission position corresponds to a second antenna port, and a DD domain coordinate of the first reference signal transmission position is (lₚ, kₚ); a DD domain coordinate of the second reference signal transmission position is (lₚ, kₚ+2kᵥ+1); a delay domain coordinate range of the guard interval is from lₚ−l_{τ} to lₚ+l_{τ}, and a Doppler domain coordinate range of the guard interval is from kₚ−2kᵥ to kₚ+4kᵥ+1; a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+4kᵥ+2 to N−1.

In some embodiments of the disclosure, in a case where the number of antenna ports is 4, a first reference signal transmission position corresponds to a first antenna port, a second reference signal transmission position corresponds to a second antenna port, a third reference signal transmission position corresponds to a third antenna port, a fourth reference signal transmission position corresponds to a fourth antenna port, and a DD domain coordinate of the first reference signal transmission position is (lₚ, kₚ); a DD domain coordinate of the second reference signal transmission position is (lₚ, kₚ+2kᵥ+1), a DD domain coordinate of the third reference signal transmission position is (lₚ+l_{τ}+1, kₚ), and a DD domain coordinate of the fourth reference signal transmission position is (lₚ+l_{τ}+1, kₚ+2kᵥ+1); a delay domain coordinate range of the guard interval is from lₚ−l_{τ} to lₚ+2l_{τ}+1, and a Doppler domain coordinate range of the guard interval is from kₚ−2kᵥ to kₚ+4kᵥ+1; a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+4kᵥ+2 to N−1.

In some embodiments of the disclosure, on a plurality of scheduling units in a DD domain, a difference between delay domain coordinates of the reference signal transmission positions corresponding to any two antenna ports is |nl_{τ}+1|, where n is a positive integer greater than or equal to 1; and a difference between Doppler domain coordinates of the reference signal transmission positions corresponding to any two antenna ports is |mkᵥ+1|, where m is an even number greater than or equal to 2.

In some embodiments of the disclosure, the receiving module 1610 is further configured to receive a signal transmitted by the transmitter device based on a scheduling unit in a DD domain, in which the reference signal pattern is mapped to the scheduling unit.

In some embodiments of the disclosure, the communication apparatus 1600 further a processing module 1620. The processing module 1620 is configured to perform any one of channel estimation, demodulation, and beam measurement based on the signal.

The disclosure further provides a reference signal pattern. The reference signal pattern is used for OTFS modulation, in which a guard interval is provided between a data transmission position and a reference signal transmission position in the reference signal pattern.

In some embodiments of the disclosure, the reference signal pattern is agreed by a protocol, and the reference signal pattern has a correlative relationship with a number of antenna ports.

In some embodiments of the disclosure, parameters of the reference signal pattern include at least one of: lₚ, a delay domain coordinate of the reference signal transmission position; kₚ, a Doppler domain coordinate of the reference signal transmission position; l_{τ}, a number of OTFS symbols occupied by the guard interval in a delay domain; or kᵥ, a number of Doppler domain OTFS subcarriers occupied by the guard interval in a Doppler domain.

In some embodiments of the disclosure, lₚ satisfies a first condition, and the first condition includes: 0<lₚ−l_{τ}<lₚ<lₚ+l_{τ}<M−1, where M represents a number of delay domain OTFS symbols in one scheduling unit; and kₚ satisfies a second condition, and the second condition includes: 0<kₚ−kᵥ<kₚ<kₚ+kᵥ<N−1, where N represents a number of Doppler domain OTFS subcarriers in one scheduling unit.

In some embodiments of the disclosure, in a case where the number of antenna ports is 1, a delay-Doppler (DD) domain coordinate of the reference signal transmission position is (lₚ, kₚ); a delay domain coordinate range of the guard interval is from lₚ−l_{τ} to lₚ+l_{τ}, and a Doppler domain coordinate range of the guard interval is from kₚ−2kᵥ to kₚ+2kᵥ; a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+2kᵥ+1 to N−1.

In some embodiments of the disclosure, in a case where the number of antenna ports is 2, a first reference signal transmission position corresponds to a first antenna port, a second reference signal transmission position corresponds to a second antenna port, and a DD domain coordinate of the first reference signal transmission position is (lₚ, kₚ); a DD domain coordinate of the second reference signal transmission position is (lₚ+l_{τ}+1, kₚ); a delay domain coordinate range of the guard interval is from lₚ−l_{τ} to lₚ+2l_{τ}+1, and a Doppler domain coordinate range of the guard interval is from kₚ−2kᵥ to kₚ+2kᵥ; a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2k_{τ}−1 and from kₚ+2kᵥ+1 to N−1.

In some embodiments of the disclosure, in a case where the number of antenna ports is 2, a first reference signal transmission position corresponds to a first antenna port, a second reference signal transmission position corresponds to a second antenna port, and a DD domain coordinate of the first reference signal transmission position is (lₚ, kₚ); a DD domain coordinate of the second reference signal transmission position is (lₚ, kₚ+2kᵥ+1); a delay domain coordinate range of the guard interval is from lₚ−l_{τ} to lₚ+l_{τ}, and a Doppler domain coordinate range of the guard interval is from kₚ−2kᵥ to kₚ+4kᵥ+1; a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+4kᵥ+2 to N−1.

In some embodiments of the disclosure, in a case where the number of antenna ports is 4, a first reference signal transmission position corresponds to a first antenna port, a second reference signal transmission position corresponds to a second antenna port, a third reference signal transmission position corresponds to a third antenna port, a fourth reference signal transmission position corresponds to a fourth antenna port, and a DD domain coordinate of the first reference signal transmission position is (lₚ, kₚ); a DD domain coordinate of the second reference signal transmission position is (lₚ, kₚ+2kᵥ+1), a DD domain coordinate of the third reference signal transmission position is (lₚ+l_{τ}+1, kₚ), and a DD domain coordinate of the fourth reference signal transmission position is (lₚ+l_{τ}+1, kₚ+2kᵥ+1); a delay domain coordinate range of the guard interval is from lₚ+l_{τ} to lₚ+2l_{τ}+1, and a Doppler domain coordinate range of the guard interval is from kₚ−2kᵥ to kₚ+4kᵥ+1; a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+4kᵥ+2 to N−1.

In some embodiments of the disclosure, on a plurality of scheduling units in a DD domain, a difference between delay domain coordinates of the reference signal transmission positions corresponding to any two antenna ports is |nl_{τ}+1|, where n is a positive integer greater than or equal to 1; and a difference between Doppler domain coordinates of the reference signal transmission positions corresponding to any two antenna ports is |mkᵥ+1|, where m is an even number greater than or equal to 2.

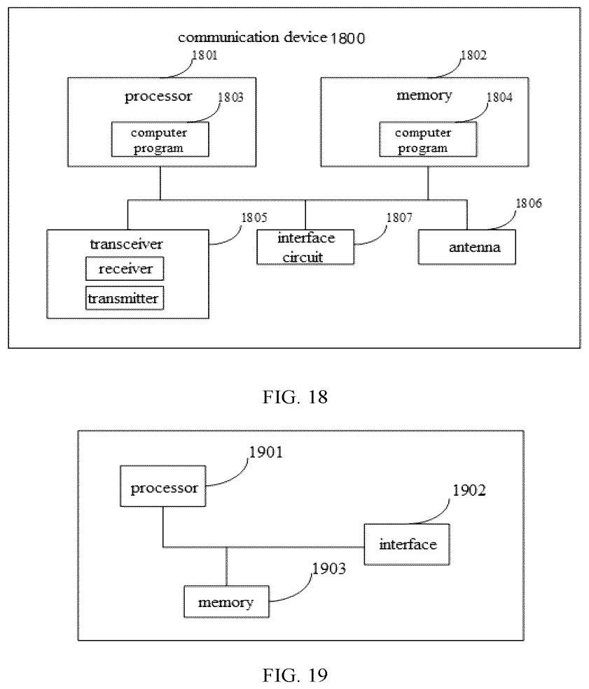

Please refer to FIG. 18, FIG. 18 is a block diagram of a communication device 1800 according to an embodiment of the disclosure. The communication device 1800 may be a network device, or a terminal, or a chip, a chip system, a processor, etc. that supports the network device to implement the method, or a chip, a chip system, a processor, etc. that supports the terminal to implement the method. The communication device 1800 may be configured to implement the method in the above method embodiments. For details, please refer to the description in the above method embodiments.

The communication device 1800 may include one or more processors 1801. The processor 1801 may be a general-purpose processor or a special-purpose processor. For example, it may be a baseband processor or a central processing unit. The baseband processor is configured to process communication protocols and communication data, and the central processor is configured to control communication apparatuses (such as base stations, baseband chips, terminals, terminal chips, DU or CU, etc.) to execute computer programs and process computer program data.

In some implementations, the communication device 1800 may also include one or more memories 1802 on which a computer program 1804 is stored. When the computer program 1804 is executed by the processor 1801, the communication device 1800 implements the method in the above method embodiments. In some implementations, the memory 1802 may also store data. The communication device 1800 and the memory 1802 may be set separately or integrated together.

In some implementations, the communication device 1800 may also include a transceiver 1805 and an antenna 1806. The transceiver 1805 may be called a transceiving unit, a transceiving machine, or a transceiving circuit, etc., to achieve a transceiving function. The transceiver 1805 may include a receiver and a transmitter. The receiver may be called a receiving machine or a receiving circuit, etc., to achieve a receiving function; and the transmitter may be called a transmitting machine or a transmitting circuit, etc., to achieve a transmitting function.

In some implementations, the communication device 1800 includes one or more interface circuits 1807. The interface circuit 1807 is configured to receive code instructions and transmit the code instructions to the processor 1801. When the code instructions are running on the processor 1801, the communication device 1800 is caused to implement the method in the above method embodiments.

In an implementation, the processor 1801 may include a transceiver configured to achieve the receiving and transmitting function. For example, the transceiver may be a transceiving circuit, or an interface, or an interface circuit. The transceiving circuit, the interface, or the interface circuit configured to achieve the receiving and transmitting function may be set separately or integrated together. The transceiving circuit, the interface or the interface circuit may be configured to read and write code/data, or the transceiving circuit, the interface or the interface circuit may be configured to transmit or convey signals.

In an implementation, the processor 1801 may store a computer program 1803. When the computer program 1803 is running on the processor 1801, the communication device 1800 is caused to implement the method in the above method embodiments. The computer program 1803 may be solidified in the processor 1801. In this way, the processor 1801 may be implemented in hardware.

In an implementation, the communication device 1800 may include a circuit that may achieve the transmitting or receiving or communicating function in the above method embodiments. The processor and transceiver in the disclosure may be implemented in an integrated circuit (IC), an analog IC, a radio frequency integrated circuit (RFIC), a mixed-signal IC, an application specific integrated circuit (ASIC), a printed circuit board (PCB), an electronic equipment, etc. The processor and transceiver may also be manufactured with various IC process technologies, such as a complementary metal oxide semiconductor (CMOS), nMetal-oxide-semiconductor (NMOS), a positive channel metal oxide semiconductor (PMOS), a bipolar junction transistor (BJT), a bipolar CMOS (BiCMOS), silicon germanium (SiGe), gallium arsenide (GaAs), etc.

The communication apparatus in the above embodiments may be a network device or a terminal, but the scope of the communication apparatus in the disclosure is not limited to this, and the structure of the communication apparatus may not be restricted by FIG. 18. The communication apparatus may be an independent device or part of a larger device. For example, the communication apparatus may be:
(1) an independent IC, or a chip, or a chip system or a subsystem;
(2) a collection including one or more IC, in some implementation, the IC collection may also include storage components for storing data and computer programs;
(3) an ASIC, such as a modem;
(4) modules embedded in other devices;
(5) a receiver, a terminal, an intelligent terminal, a cellular phone, a wireless device, a handheld phone, a mobile unit, a vehicle-mounted device, a network device, a cloud device, an artificial intelligence device, etc.;
(6) others.

For the case where the communication apparatus may be a chip or a chip system, please refer to FIG. 19, which is a schematic diagram of a chip provided by an embodiment of the disclosure. A chip in the FIG. 19 includes a processor 1901 and an interface 1902. There may be one or more processors 1901, and there may be one or more interfaces 1902.

In some embodiments, the chip further includes a memory 1903 for storing necessary computer programs and data.

Those skilled in the art may also understand that the various illustrative logical blocks and steps listed in the embodiments of the disclosure may be implemented by electronic hardware, computer software, or their combination. Whether such a function is implemented in hardware or software depends on specific applications and design requirements of the overall system. Those skilled in the art may, for each specific application, use a variety of methods to achieve the above function, but such implementation shall not be regarded as going beyond the scope of the protection of the embodiments of the disclosure.

The disclosure also provides a readable storage medium having instructions stored thereon that, when executed by a computer, implement the functions of any of the foregoing method embodiments.

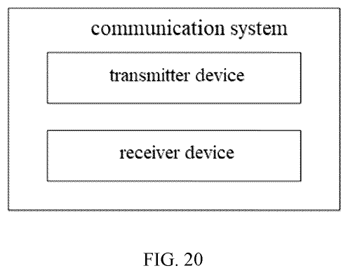

FIG. 20 is a schematic diagram of a communication system provided by an embodiment of the present disclosure. As shown in FIG. 20, the communication system includes: a transmitter device configured to execute the methods shown in FIGS. 2-10 above; and a receiver device configured to execute the methods shown in FIGS. 11 and 12 above.

In the above embodiments, the functions may be wholly or partially implemented by software, hardware, firmware, or any combination of them. When implemented by software, the functions may be implemented in whole or in part in the form of a computer program product. The computer program product includes one or more computer programs. Procedures or functions according to embodiments of the disclosure are wholly or partially generated when the computer program is loaded and executed on a computer. The computer may be a general purpose computer, a special purpose computer, a computer network, or other programmable device. The computer program may be stored in a computer-readable storage medium or transmitted from one computer-readable storage medium to another. For example, the computer program may be transmitted from one website, computer, server, or data center to another website, computer, server, or data center via wire (such as a coaxial cable, a fiber optic, a digital subscriber line (DSL)) or wireless (such as infrared, wireless, microwave). The computer-readable storage medium may be any available medium that may be accessed by a computer, or a data storage device such as a server that integrates one or more of the available media, and a data center. The available medium may be a magnetic medium (such as a floppy disk, a hard disk and a magnetic tape), an optical medium (such as a digital video disk (DVD)), or a semiconductor medium (such as a solid state disk (SSD)).

Those skilled in the art may understand that various numbers such as first and second involved in the disclosure are distinguished merely for convenience of description, and are not intended to limit the scope of embodiments of the disclosure, but also to indicate an order of precedence.

The term “at least one” in the disclosure may also be described as one or more, and the more may be two, three, four, or more, which is not limited in the disclosure. In the embodiment of the disclosure, for a technical feature, the technical features in the technical feature are distinguished by terms “first”, “second”, “third”, “A”, “B”, “C” and “D”, etc., and the technical features described by the terms “first”, “second”, “third”, “A”, “B”, “C” and “D”, etc. are not in a sequential order or in an order of size.

Corresponding relationships indicated by tables in the disclosure may be configured or predefined. Values of information in the tables are only examples, and may be configured as other values, which are not limited in the disclosure. When the corresponding relationship between information and parameters is configured, it is not always necessary to configure all corresponding relationships indicated in tables. For example, in the tables of the disclosure, corresponding relationships indicated by some rows may not be configured. For another example, appropriate transformations and adjustments, such as splitting and merging, may be made based on the above tables. Names of parameters shown in headers of the tables may be other names understandable by the communication apparatus, and values or representations of the parameters may be other values or representations understandable by the communication apparatus. When the above tables are implemented, other data structures may be used, for example, arrays, queues, containers, stacks, linear lists, pointers, linked lists, trees, graphs, structures, classes, heaps or hash tables may be used.

Predefined in the disclosure may be understood as defined, predefined, stored, pre-stored, pre-negotiated, pre-configured, solidified or pre-fired.

Those skilled in the related art may realize that, in combination with units and algorithm steps of the examples described in embodiments of the disclosure, may be implemented by electronic hardware or a combination of electronic hardware and computer software. Whether the functions are executed by hardware or software depends on a specific application and a design constraint of the technical solutions. Those skilled in the art may adopt different methods for each specific application to implement the described functions, but such implementation should not be considered as going beyond the scope of the disclosure.

Those skilled in the art may clearly understand that, a specific working process of a system, an apparatus and a unit described above may refer to a corresponding process in the above method embodiments, which will not be repeated here.

The above are only implementations of the disclosure. However, the protection scope of the disclosure is not limited here. Changes and substitutions that may be easily considered by those skilled in the art shall be included within the protection scope of the disclosure. Therefore, the protection scope of the disclosure shall be subject to the protection scope of claims.

1. A communication method, performed by a transmitter device, comprising:
determining a reference signal pattern,
wherein the reference signal pattern is used for an orthogonal time frequency space (OTFS) modulation system, and a guard interval is provided between a data transmission position and a reference signal transmission position in the reference signal pattern.

2. The communication method of claim 1, wherein determining the reference signal pattern comprises:
determining a number of antenna ports, wherein the number of antenna ports is a positive integer; and
determining the reference signal pattern corresponding to the number of antenna ports.

3. The communication method of claim 2, wherein parameters of the reference signal pattern comprises at least one of:
lₚ, a delay domain coordinate of the reference signal transmission position;
kₚ, a Doppler domain coordinate of the reference signal transmission position;
l_{τ}, a number of OTFS symbols occupied by the guard interval in a delay domain; or
kᵥ, a number of Doppler domain OTFS subcarriers occupied by the guard interval in a Doppler domain.

4. The communication method of claim 3, wherein
lₚ satisfies a first condition, and the first condition comprises:
0<lₚ−l_{τ}<lₚ<lₚ+l_{τ}<M−1, where M represents a number of delay domain OTFS symbols in one scheduling unit; and
kₚ satisfies a second condition, and the second condition comprises:
0<kₚ−kᵥ<kₚ<kₚ+kᵥ<N−1, where N represents a number of Doppler domain OTFS subcarriers in one scheduling unit.

5. The communication method of claim 4, wherein in a case where the number of antenna ports is 1, a delay-Doppler (DD) domain coordinate of the reference signal transmission position is (lₚ, kₚ);
a delay domain coordinate range of the guard interval is from lₚ−l_{τ} to lₚ+l_{τ}, and a Doppler domain coordinate range of the guard interval is from kₚ−2kᵥ to kₚ+2kᵥ;
a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+2kᵥ+1 to N−1.

6. The communication method of claim 4, wherein in a case where the number of antenna ports is greater than or equal to 2, determining the reference signal pattern corresponding to the number of antenna ports comprises:
determining a first reference signal transmission position, wherein the first reference signal transmission position is the reference signal transmission position corresponding to a first antenna port; and
determining a second reference signal transmission position based on the first reference signal transmission position, wherein the second reference signal transmission position is the reference signal transmission position corresponding to a second antenna port;
wherein in a case where the number of antenna ports is 2, a DD domain coordinate of the first reference signal transmission position is (lₚ, kₚ);
a DD domain coordinate of the second reference signal transmission position is (lₚ+l_{τ}+1, kₚ);
a delay domain coordinate range of the guard interval is from lₚ−l_{τ} to lₚ+2l_{τ}+1, and a Doppler domain coordinate range of the guard interval is from kₚ−2kᵥ to kₚ+2kᵥ;
a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+2kᵥ+1 to N−1; or
wherein in a case where the number of antenna ports is 2, a DD domain coordinate of the first reference signal transmission position is (lₚ, kₚ);
a DD domain coordinate of the second reference signal transmission position is (lₚ, kₚ+2kᵥ+1);
a delay domain coordinate range of the guard interval is from lₚ−l_{τ} to lₚ+l_{τ}, and a Doppler domain coordinate range of the guard interval is from kₚ−2kᵥ to kₚ+4kᵥ+1;
a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+4kᵥ+2 to N−1; or
wherein in a case where the number of antenna ports is 4, a third reference signal transmission position corresponds to a third antenna port, a fourth reference signal transmission position corresponds to a fourth antenna port, and a DD domain coordinate of the first reference signal transmission position is (lₚ, kₚ);
a DD domain coordinate of the second reference signal transmission position is (lₚ, kₚ+2kᵥ+1), a DD domain coordinate of the third reference signal transmission position is (lₚ+l_{τ}+1, kₚ), and a DD domain coordinate of the fourth reference signal transmission position is (lₚ+l_{τ}+1, kₚ+2kᵥ+1);
a delay domain coordinate range of the guard interval is from lₚ−l_{τ} to lₚ+2l_{τ}+1, and a Doppler domain coordinate range of the guard interval is from kₚ−2kᵥ to kₚ+4kᵥ+1;
a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+4kᵥ+2 to N−1.

7-9. (canceled)

10. The communication method of claim 1, wherein on a plurality of scheduling units in a DD domain, a difference between delay domain coordinates of the reference signal transmission positions corresponding to any two antenna ports is |nl_{τ}+1|, where n is a positive integer greater than or equal to 1; and a difference between Doppler domain coordinates of the reference signal transmission positions corresponding to any two antenna ports is |mkᵥ+1|, where m is an even number greater than or equal to 2.

11. The communication method of claim 1, further comprising:
indicating the reference signal pattern to a receiver device.

12. The communication method of claim 1, further comprising:
mapping the reference signal pattern to a scheduling unit in a DD domain; and
transmitting a signal based on the scheduling unit.

13. A communication method, performed by a receiver device, comprising:
receiving a reference signal pattern indicated by a transmitter device,
wherein the reference signal pattern is used for an orthogonal time frequency space (OTFS) modulation system, and a guard interval is provided between a data transmission position and a reference signal transmission position in the reference signal pattern.

14. The method according to claim 13, wherein the reference signal pattern is agreed by a protocol, and the reference signal pattern has a correlative relationship with a number of antenna ports.

15. The communication method of claim 13, wherein parameters of the reference signal pattern comprises at least one of:
lₚ, a delay domain coordinate of the reference signal transmission position;
kₚ, a Doppler domain coordinate of the reference signal transmission position;
l_{τ}, a number of OTFS symbols occupied by the guard interval in a delay domain; or
kᵥ, a number of Doppler domain OTFS subcarriers occupied by the guard interval in a Doppler domain.

16. The communication method of claim 15, wherein
lₚ satisfies a first condition, and the first condition comprises:
0<lₚ−l_{τ}<lₚ<lₚ+l_{τ}<M−1, where M represents a number of delay domain OTFS symbols in one scheduling unit; and
kₚ satisfies a second condition, and the second condition comprises:
0<kₚ−kᵥ<kₚ<kₚ+kᵥ<N−1, where N represents a number of Doppler domain OTFS subcarriers in one scheduling unit.

17. The communication method of claim 16, wherein in a case where the number of antenna ports is 1, a delay-Doppler (DD) domain coordinate of the reference signal transmission position is (lₚ, kₚ);
a delay domain coordinate range of the guard interval is from lₚ−l_{τ} to lₚ+l_{τ}, and a Doppler domain coordinate range of the guard interval is from kₚ−2kᵥ to kₚ+2kᵥ;
a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+2kᵥ+1 to N−1; or
wherein in a case where the number of antenna ports is 2, a first reference signal transmission position corresponds to a first antenna port, a second reference signal transmission position corresponds to a second antenna port, and a DD domain coordinate of the first reference signal transmission position is (lₚ, kₚ);
a DD domain coordinate of the second reference signal transmission position is (lₚ+l_{τ}+1, kₚ);
a delay domain coordinate range of the guard interval is from lₚ−l_{τ} to lₚ+2l_{τ}+1, and a Doppler domain coordinate range of the guard interval is from kₚ−2kᵥ to kₚ+2kᵥ;
a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from kₚ+2kᵥ+1 to N−1; or
wherein in a case where the number of antenna ports is 2, a first reference signal transmission position corresponds to a first antenna port, a second reference signal transmission position corresponds to a second antenna port, and a DD domain coordinate of the first reference signal transmission position is (lₚ, kₚ);
a DD domain coordinate of the second reference signal transmission position is (lₚ, kₚ+2kᵥ+1);
a delay domain coordinate range of the guard interval is from lₚ−l_{τ} to lₚ+l_{τ}, and a Doppler domain coordinate range of the guard interval is from kₚ−2kᵥ to kₚ+4kᵥ+1;
a delay domain coordinate range of the data transmission position is from 0 to lₚ−l_{τ}−1 and from lₚ+l_{τ}+1 to M−1, and a Doppler domain coordinate range of the data transmission position is from 0 to kₚ−2kᵥ−1 and from kₚ+4kᵥ+2 to N−1; or
wherein in a case where the number of antenna ports is 4, a first reference signal transmission position corresponds to a first antenna port, a second reference signal transmission position corresponds to a second antenna port, a third reference signal transmission position corresponds to a third antenna port, a fourth reference signal transmission position corresponds to a fourth antenna port, and a DD domain coordinate of the first reference signal transmission position is (lₚ, kₚ);
a DD domain coordinate of the second reference signal transmission position is (lₚ, kₚ+2kᵥ+1), a DD domain coordinate of the third reference signal transmission position is (lₚ+l_{τ}+1, kₚ), and a DD domain coordinate of the fourth reference signal transmission position is (lₚ+l_{τ}+1, kₚ+2kᵥ+1);
a delay domain coordinate range of the guard interval is from lₚ−l_{τ} to lₚ+2l_{τ}+1, and a Doppler domain coordinate range of the guard interval is from kₚ−2kᵥ to kₚ+4kᵥ+1;
a delay domain coordinate range of the data transmission position is from 0 to lₚ−l_{τ}−1 and from lₚ+2l_{τ}+2 to M−1, and a Doppler domain coordinate range of the data transmission position is from 0 to kₚ−2kᵥ−1 and from e to N−1.

18-21. (canceled)

22. The communication method of claim 13, further comprising:
receiving a signal transmitted by the transmitter device based on a scheduling unit in a DD domain, wherein the reference signal pattern is mapped to the scheduling unit;
mapping the reference signal pattern to a scheduling unit in a DD domain; and
performing any one of channel estimation, demodulation, and beam measurement based on the signal

23-25. (canceled)

26. A reference signal pattern, used for orthogonal time frequency space (OTFS) modulation, wherein a guard interval is provided between a data transmission position and a reference signal transmission position in the reference signal pattern.

27-34. (canceled)

35. A communication apparatus, comprising:
a transceiver;
a memory; and
a processor connected to the transceiver and the memory respectively,
wherein the processor is configured to control wireless signal transmission and reception of the transceiver by executing computer-executable instructions on the memory, and capable of implementing the method according to claim 1.

36. A computer storage medium storing computer-executable instructions which, when executed by a processor, cause the method according to claim 1 to be implemented.

37. (canceled)

38. A communication apparatus, comprising:
a transceiver,
a memory; and
a processor connected to the transceiver and the memory respectively,
wherein the processor is configured to control wireless signal transmission and reception of the transceiver by executing computer-executable instructions on the memory, and capable of implementing the method according to claim 13.

39. A non-transitory computer storage medium storing computer-executable instructions which, when executed by a processor, cause the method according to claim 13 to be implemented.
